(19) United States
(12) Patent Application Publication
(10) Pub. No.: US 2021/0145177 A1
(43) Pub. Date: May 20, 2021

(54) PIVOTAL SUPPORTING SYSTEM HAVING SUPPORTING LEVER WITH ATTRACTIVE COVER

(71) Applicant: Oxti Corporation, Taipei (TW)

(72) Inventor: Chih Feng HO, Taipei (TW)

(21) Appl. No.: 16/689,125

(22) Filed: Nov. 20, 2019

(51) Int. Cl. A47B 96/20; F16M 11/12; A47B 23/04

(52) U.S. Cl. CPC A47B 96/20; F16M 11/12; A47B 2023/047; A47B 2096/209; F16M 2200/06; A47B 23/046

(57) ABSTRACT

A pivotal supporting system includes a supporting column disposed on a supporting base, and a supporting lever includes a housing attached to the supporting column for supporting a remote member on the supporting base, the supporting lever includes a housing having a chamber formed in the housing, a number of magnetic attractive members attached to the housing, a cover, and a number of magnetic attractive elements attached to the cover and engaged with the magnetic attractive members of the housing for anchoring the cover to the housing and for allowing the cover to be easily and quickly and readily attached to the supporting lever without screws or bolts or fastener members.

### BACKGROUND OF THE INVENTION

### 1. Field of the Invention

The present invention relates to a pivotal supporting system for a remote member, such as a monitor, displayer, portable phone, television, keyboard, or the like, and more particularly to a pivotal supporting system including a supporting lever or arm having a cover attached or mounted or secured to the supporting lever or arm with a number of magnetic attractive members or elements for allowing the cover to be easily and quickly and readily attached or mounted or secured to the supporting lever or arm without screws or bolts or fastener members.

### 2. Description of the Prior Art

Various kinds of typical supporting devices or apparatuses have been developed and provided for supporting a remote member, such as a monitor, displayer, portable phone, television, keyboard, or the like.

For example, U.S. Pat. No. 6,012,693 to Voeller et al., U.S. Pat. No. 6,315,259 B1 to Kolb, U.S. Pat. No. 6,394,403 B1 to Hung, U.S. Pat. No. 6,478,275 B1 to Huang, U.S. Pat. No. 6,769,657 B1 to Huang, U.S. Pat. No. 6,822,857 B2 to Jung et al., U.S. Pat. No. 6,863,252 B2 to Bosson, and U.S. Pat. No. 7,413,152 B1 to Chen disclose several of the typical supporting devices or apparatuses for supporting a remote member. The typical supporting devices normally comprise a supporting lever or arm for engaging with and for supporting a remote member.

However, the supporting lever or arm normally includes one or more parts or elements or covers that are required to be attached or mounted or secured to the supporting lever or arm with a number of screws or bolts or fastener members, and it is time consuming to drill and form the screw holes or the like in the supporting lever or arm and/or in the cover, and it is time consuming to screw or fasten the parts or elements or covers to the supporting lever or arm.

The present invention has arisen to mitigate and/or obviate the afore-described disadvantages of the conventional pivotal supporting devices.

### SUMMARY OF THE INVENTION

The primary objective of the present invention is to provide a pivotal supporting system including a supporting lever or arm having a cover attached or mounted or secured to the supporting lever or arm with a number of magnetic attractive members or elements for allowing the cover to be easily and quickly and readily attached or mounted or secured to the supporting lever or arm without screws or bolts or fastener members.

In accordance with one aspect of the invention, there is provided a pivotal supporting system comprising a supporting base, a supporting column disposed on the supporting base, and a supporting lever including a housing attached to the supporting column for supporting a remote member on the supporting base, the supporting lever including a housing including a chamber formed in the housing, a number of magnetic attractive members attached to the housing, a cover, and a number of magnetic attractive elements attached to the cover and arranged or located close to the magnetic attractive members and arranged for engaging with the magnetic attractive members of the housing for anchoring the cover to the housing and for preventing the cover from being disengaged or separated from the housing, and for allowing the cover to be easily and quickly and readily attached or mounted or secured to the supporting lever or arm without screws or bolts or fastener members.

The housing includes an outer peripheral wall for forming and defining the chamber of the housing. The magnetic attractive members of the housing are attached to the peripheral wall and arranged or located close to the magnetic attractive elements of the cover.

The housing includes a side portion, and a notch formed in the peripheral wall at the side portion of the peripheral wall of the housing. The notch of the peripheral wall is communicating with the chamber of the housing for allowing the cover to be easily and quickly opened or disengaged or separated from the housing with or through the notch of the housing.

The magnetic attractive members of the housing are arranged in an elliptical arrangement. The magnetic attractive elements of the cover are also arranged in an elliptical arrangement corresponding to the magnetic attractive members of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating the operation of a pivotal supporting system in accordance with the present invention;

FIG. 2 is a partial perspective view of the pivotal supporting system;

FIG. 3 is a partial exploded view of the pivotal supporting system; and

FIG. 4 is another partial exploded view illustrating another arrangement of the pivotal supporting system.

### DETAILED DESCRIPTION OF THE PREFERRED EMBODIMENT

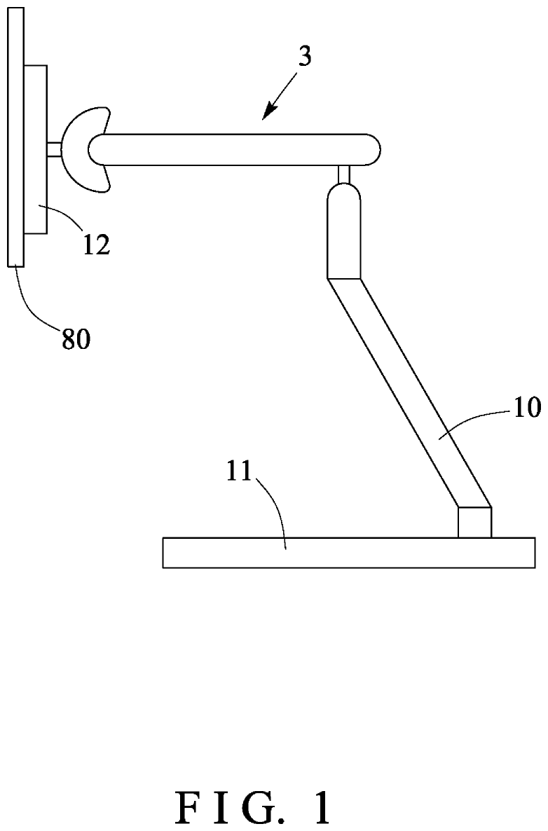

Referring to the drawings, and initially to FIG. 1, a pivotal supporting system in accordance with the present invention comprises a pivotal supporting column 10 to be provided or disposed or engaged onto a supporting stand or a supporting base 11 for pivotally supporting a supporting lever or arm 3, a supporting member or carrier 12, and/or a remote member 80, such as a monitor, displayer, portable phone, television, keyboard, or the like.

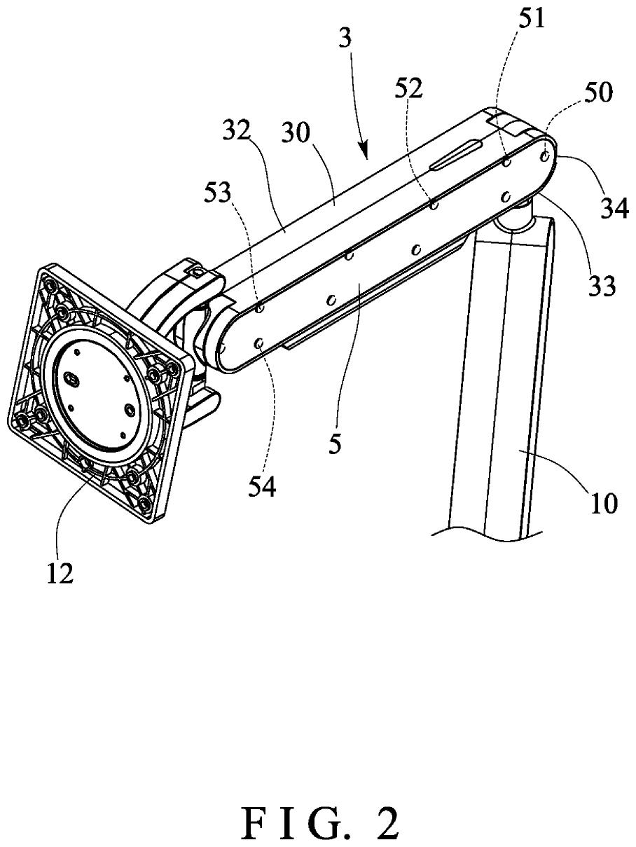

As shown in FIGS. 2-4, the supporting lever 3 includes a tubular or longitudinal member or housing 30 to be disposed or engaged or secured onto the pivotal supporting column 10, the housing 30 includes a compartment or chamber 31 formed therein and formed or defined by an outer peripheral wall 32, and for forming or defining an opened side portion 33, and includes an opening or notch 34 formed in the outer peripheral wall 32 at the side portion 33 of the outer peripheral wall 32 and/or of the housing 30, and communicating with the chamber 31 of the housing 30.

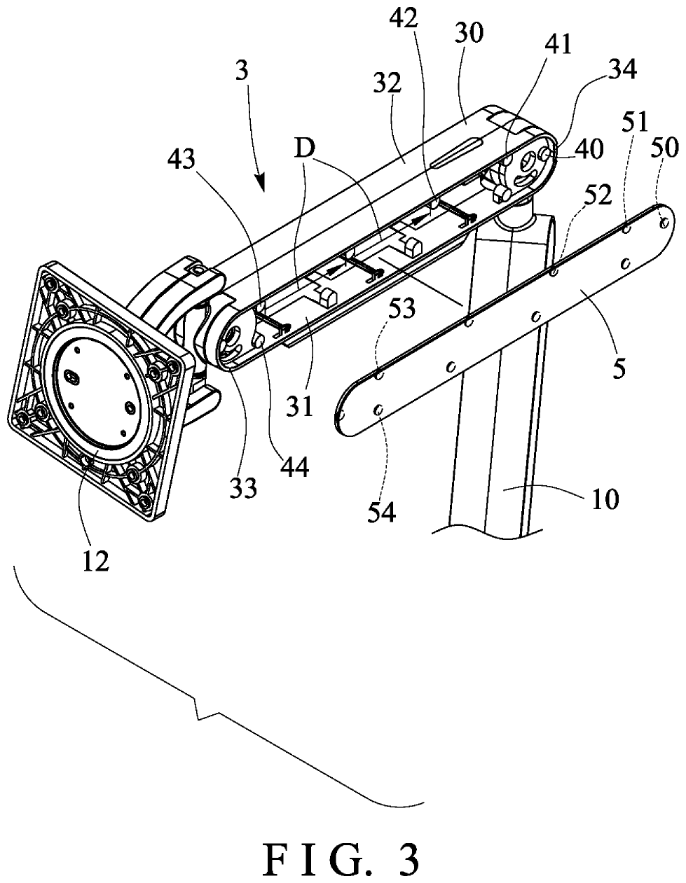

The supporting lever 3 further includes one or more (such as a number of) magnetic attractive members 40, 41, 42, 43, 44 . . . attached or mounted or secured to the housing 30, it is preferable, but not necessary that the magnetic attractive members 40, 41, 42, 43, 44 are attached or mounted or secured to the peripheral wall 32 of the housing 30 and arranged or located close to or at the side portion 33 of the outer peripheral wall 32 and/or of the housing 30, and preferably arranged or installed in a circular or annular or peripheral or oval or elliptical structure or arrangement, as shown in FIG. 3. It is further preferable that the magnetic attractive members 40, 41, 42, 43, 44 are located and arranged to be equally spaced from each other for a distance “D”.

The supporting lever 3 further includes a cap or cover 5 to be provided or disposed or engaged into the chamber 31 at the side portion 33 of the outer peripheral wall 32 and/or of the housing 30, and the cover 5 includes one or more (such as a number of) magnetic attractive elements 50, 51, 52, 53, 54 . . . attached or mounted or secured to the cover 5 and arranged or installed or located close to or adjacent to the corresponding magnetic attractive members 40, 41, 42, 43, 44 . . . of the housing 30, for acting or engaging with the corresponding magnetic attractive members 40, 41, 42, 43, 44 . . . of the housing 30 and for attracting or anchoring or retaining or positioning the cover 5 to the housing 30, and for preventing the cover 5 from being disengaged or separated from the housing 30.

The magnetic attractive members 40, 41, 42, 43, 44 . . . of the housing 30 and the magnetic attractive elements 50, 51, 52, 53, 54 . . . of the cover 5 may be selected from a permanent magnet, composite or polymer materials mixed or blended with magnetic attractive powders or materials or the like, magnetizable metal materials, such as iron, nickel, steel, cobalt, etc., and arranged for allowing the magnetic attractive members 40, 41, 42, 43, 44 . . . of the housing 30 and the magnetic attractive elements 50, 51, 52, 53, 54 . . . of the cover 5 to be attracted or engaged with each other. The cover 5 may be opened or disengaged or separated from the housing 30 with or through the notch 34 of the housing 30.

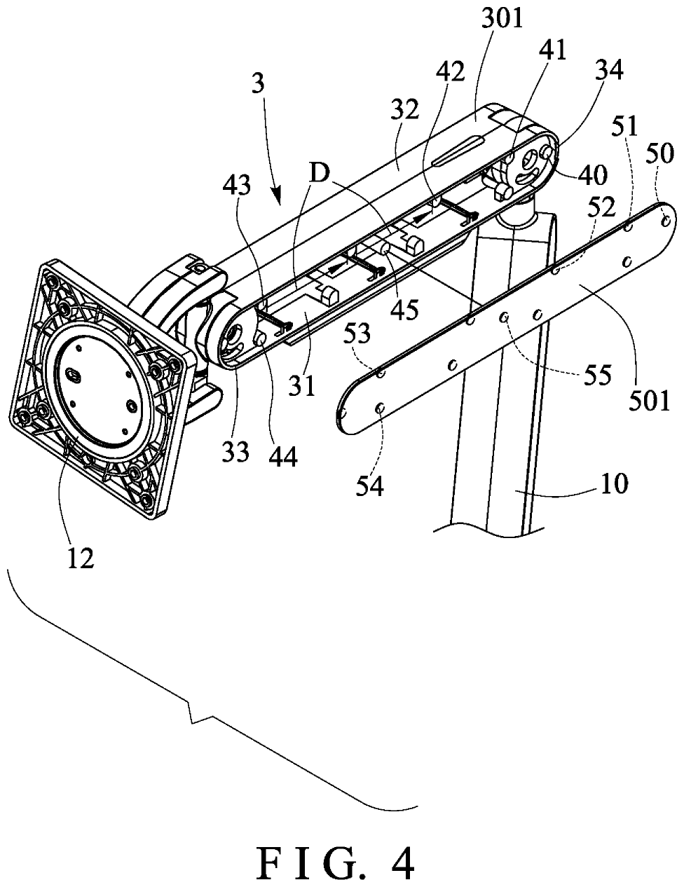

As shown in FIG. 4, in addition to the magnetic attractive members 40, 41, 42, 43, 44 . . . of the housing 301 that are arranged in a peripheral or oval or elliptical structure or arrangement or status, the housing 301 may include one or more further magnetic attractive members 45 attached or mounted or secured to the housing 301 and arranged or located outside or beyond the peripheral or oval or elliptical arrangement or status of the magnetic attractive members 40, 41, 42, 43, 44. The cover 501 may also include one or more further magnetic attractive elements 55 attached or mounted or secured to the cover 501 and arranged or located outside or beyond the peripheral or oval or elliptical arrangement or status of the magnetic attractive elements 50, 51, 52, 53, 54, and arranged for allowing the magnetic attractive members 45 of the housing 301 and the magnetic attractive elements 55 of the cover 501 to be attracted or engaged with each other.

In operation, shown in FIG. 3, the cover 5 may be easily and quickly and readily attached or mounted or secured to the housing 30 at the side portion 33 of the outer peripheral wall 32 and/or of the housing 30, and attracted or anchored or retained or positioned to the housing 30 with the magnetic attractive members 40, 41, 42, 43, 44 . . . of the housing 30 and the magnetic attractive elements 50, 51, 52, 53, 54 . . . of the cover 5, without any screw or bolt or fastener members, and the cover 5 may be opened or disengaged or separated from the housing 30 with or through the notch 34 of the housing 30.

Accordingly, the pivotal supporting system in accordance with the present invention includes a supporting lever or arm having a cover attached or mounted or secured to the supporting lever or arm with a number of magnetic attractive members or elements for allowing the cover to be easily and quickly and readily attached or mounted or secured to the supporting lever or arm without screws or bolts or fastener members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pivotal supporting system comprising:
a supporting base,
a supporting column disposed on said supporting base, and
a supporting lever including a housing attached to said supporting column for supporting a remote member on said supporting base, said supporting lever including:
a housing including a chamber formed in said housing,
a plurality of magnetic attractive members attached to said housing,
a cover, and
a plurality of magnetic attractive elements attached to said cover and engaged with said magnetic attractive members of said housing for anchoring said cover to said housing.

2. The pivotal supporting system as claimed in claim 1, wherein said housing includes an outer peripheral wall for forming and defining said chamber of said housing.

3. The pivotal supporting system as claimed in claim 2, wherein said magnetic attractive members of said housing are attached to said peripheral wall.

4. The pivotal supporting system as claimed in claim 2, wherein said housing includes a side portion, and a notch formed in said peripheral wall at said side portion of said peripheral wall of said housing.

5. The pivotal supporting system as claimed in claim 4, wherein said notch of said peripheral wall is communicating with said chamber of said housing.

6. The pivotal supporting system as claimed in claim 1, wherein said magnetic attractive members of said housing are arranged in an elliptical arrangement.

7. The pivotal supporting system as claimed in claim 1, wherein said magnetic attractive elements of said cover are arranged in an elliptical arrangement.
